(19) United States
(12) Patent Application Publication
(10) Pub. No.: US 2007/0102477 A1
(43) Pub. Date: May 10, 2007

(54) Imaging system and method for a stencil printer

(75) Inventor: David P. Prince, Wakefield, RI (US)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: Speedline Technologies, Inc., Franklin, MA (US)

(21) Appl. No.: 11/272,192

(22) Filed: Nov. 10, 2005

(51) Int. Cl. B23K 1/08; B23K 37/06; B23K 31/02

(52) U.S. Cl. 228/39; 228/180.22

(57) ABSTRACT

A stencil printer for depositing solder paste onto a plurality of pads of an electronic substrate includes a frame and a stencil coupled to the frame. The stencil has a plurality of apertures formed therein. The stencil printer further includes a support assembly coupled to the frame, the support assembly supporting the electronic substrate in a printing position. An imaging system is adapted to capture images of multiple areas of one of the electronic substrate and the stencil. A controller, coupled to the imaging system, is adapted to control movement of the imaging system to capture an image of an area while maintaining a minimum velocity above zero when capturing the image of the area. Methods for dispensing solder paste on a substrate and for inspecting the substrate are further disclosed.

### FIELD OF THE INVENTION

The present invention relates to apparatuses and processes for dispensing material, and more particularly to an apparatus and process for dispensing solder paste through a screen or stencil printer onto an electronic substrate, such as a printed circuit board.

### BACKGROUND OF THE INVENTION

In typical surface-mount circuit board manufacturing operations, a stencil printer is used to print solder paste onto a circuit board. Typically, a circuit board having a pattern of pads or some other conductive surface onto which solder paste will be deposited is automatically fed into the stencil printer and one or more small holes or marks on the circuit board, called fiducials, is used to properly align the circuit board with a stencil or screen of the printer prior to the printing of solder paste onto the circuit board. After the circuit board is aligned, the board is raised to the stencil (or in some configurations, the stencil is lowered to the circuit board), solder paste is dispensed onto the stencil, and a wiper blade (or squeegee) traverses the stencil to force the solder paste through apertures formed in the stencil and onto the board.

In some prior art stencil printers, a dispensing head delivers solder paste between first and second wiper blades, wherein during a print stroke one of the wiper blades is used to move or roll solder paste across the stencil. The first and second wiper blades are used on alternating boards to continually pass the roll of solder paste over the apertures of a stencil to print each successive circuit board. The wiper blades are typically at a predetermined angle with the stencil to apply downward pressure on the solder paste to force the solder paste through the apertures of the stencil.

After solder paste is deposited onto the circuit board, an imaging system is employed to take images of areas of the circuit board and/or the stencil for, in certain instances, the purpose of inspecting the accuracy of the deposit of solder paste on the pads of the circuit board. Another application of the imaging system involves the aforementioned aligning of the stencil and the circuit board prior to printing in order to register the openings of the stencil with the electronic pads of the circuit board. Such imaging systems are disclosed in U.S. Pat. Nos. RE34,615 and 5,060,063, both to Freeman, which are owned by the assignee of the present invention. FIG. 1 illustrates a prior art imaging system, generally indicated at 10, which may be positioned adjacent the print nest (not shown) or attached to a gantry (not shown) to enable the imaging system to move over the print nest between a circuit board 12 and a stencil 14. Regardless of its particular configuration, the imaging system 10 is designed to take images of predefined areas of the circuit board 12 and/or the stencil 14 to either inspect the circuit board and/or the stencil or to align the stencil with the circuit board.

As shown in FIG. 1, the imaging system 10 comprises an electronic camera 16 having a lens assembly 18, two illumination devices 20, 22, two beam splitters 24, 26 and another beam splitter 28 that includes an additional mirrored surface to redirect light toward the lens assembly 18 of the camera 16. To capture an image of a predefined area of the circuit board 12, the illumination device 20 is operated to generate a beam of light that reflects off of the beam splitter 24 towards the circuit board. Light is then reflected off of the circuit board 12 back through the beam splitter 24 to the beam splitter 28, which in turn reflects the light towards lens assembly 18, and finally to the camera 16. The image of the circuit board 12 is then captured by the camera 16. Similarly, to image a predefined area of the stencil 14, the illumination device 22 is employed to generate a beam of light that reflects off of the other beam splitter 26 towards the stencil. Light reflected off of the stencil 14 is directed back through beam splitter 26 to the middle beam splitter 28 and then to the lens assembly 18 and to the camera 16 to capture the image.

With typical imaging systems, the system 10 must be moved over an area, stopped to enable the camera 16 to take an image without blur, and moved to the next area requiring imaging. FIG. 2 represents the movement of the imaging system 10, which represents schematically the velocity of the imaging system versus time. As shown, typical imaging systems come to a complete stop (i.e., velocity is zero) in order to take an image. When stopping the imaging system, further time is required to ensure that any vibration or oscillation caused by the stopping action of the imaging system gantry does not adversely affect the quality of the image taken by the camera 16. Thus, inspection of the circuit board, for example, may be a relatively lengthy process in that a multitude of areas of the circuit board must be imaged with the imaging system being stopped and moved multiple times. The captured images are next compared with corresponding areas of the stencil or areas stored by the controller of the stencil printer to determine the accuracy of the print. As a result, the sequential imaging of the areas of the circuit board may take an excessive amount of time since the imaging system must be moved over the area requiring imaging, stopped to image the area, and then moved to the next area requiring imaging.

For example, if time required to properly expose an image is approximately 30 milliseconds and the time required to move the imaging system 10 to an adjacent area is approximately 100 milliseconds, then overall time between acquisitions is approximately 130 milliseconds. In part, the image acquisition rate of the imaging system 10 is limited by the time needed to properly expose the light-sensitive electronics at the focal plane of the camera 16. Exposure time is directly related to the amount of light produced by the illumination devices, the relative brightness of the features of interest, and the lens aperture ratio or “f-stop” of the lens assembly 18. Most illumination devices that are relatively small due to space constraints are capable of generating only a relatively low level of light thus requiring a longer integration time to achieve proper exposure. To increase the speed of imaging, it is known within some imaging systems to employ two cameras, one camera to image the stencil and another camera to image the circuit board, thus reducing the time between images to align or inspect the stencil and the circuit board. However, with continuing efforts to reduce processing times at all stages of the circuit board assembly, even the provision of two cameras is often too slow for assembly lines requiring faster production rates. There is presently a need to further reduce the time it takes to image circuit boards and stencils for inspection and/or alignment purposes.

### SUMMARY OF THE INVENTION

One aspect of the present invention is directed to a stencil printer for depositing solder paste onto a plurality of pads of an electronic substrate. The stencil printer comprises a frame and a stencil coupled to the frame. The stencil has a plurality of apertures formed therein. The stencil printer further comprises a support assembly coupled to the frame, the support assembly supporting the electronic substrate in a printing position. An imaging system is constructed and arranged to capture images of multiple areas of one of the electronic substrate and the stencil. A controller, coupled to the imaging system, is constructed and arranged to control movement of the imaging system to capture an image of an area while maintaining a minimum velocity above zero when capturing the image of the area.

Embodiments of the stencil printer may include configuring the imaging system to capture an image of solder paste on a pad of the electronic substrate within the area. The imaging system comprises at least one camera, at least one lens assembly, at least one illumination device and at least one optical path adapted to reflect light between the at least one illumination device, one of the stencil and the electronic substrate, the at least one lens assembly and the at least one camera. The at least one illumination device comprises at least one light emitting diode. The optical path comprises at least one beam splitter and a mirror. In another embodiment, the imaging system comprises a first camera, a first lens assembly, a first illumination device and a first optical path adapted to reflect light between the first illumination device, the electronic substrate, the first lens assembly and the first camera, and a second camera, a second lens assembly, a second illumination device, and a second optical path adapted to reflect light between the second illumination device, the stencil, the second lens assembly and the second camera. The time to capture an image is less than five milliseconds. The controller comprises a processor programmed to perform texture recognition of the electronic substrate to determine the accuracy of the solder paste deposits on the pads of the electronic substrate. The stencil printer further comprises a dispenser, coupled to the frame, the dispenser being constructed and arranged to dispense solder paste onto the electronic substrate.

Another aspect of the invention is directed to a method for dispensing solder paste onto electronic pads of an electronic substrate. The method comprises delivering an electronic substrate to a stencil printer, positioning the electronic substrate in a print position, positioning a stencil onto the electronic substrate, performing a print operation to print solder paste onto the pads of the electronic substrate, and capturing an image of at least one area of one of the electronic substrate and the stencil while maintaining a minimum velocity above zero over the electronic substrate when capturing the at least one image.

The method may include using an imaging system to capture an image of at least one area of one of the electronic substrate and the stencil. The method may further comprise moving the imaging system from a first position that captures an image of a first area to a second position that captures an image of a second area, wherein the time to capture an image is less than five milliseconds. The method may further include performing a texture recognition sequence of the at least one area to determine the accuracy of the solder paste deposits on the pads of the electronic substrate.

Yet another aspect of the invention is directed to a stencil printer for depositing solder paste onto a plurality of pads of an electronic substrate. The stencil printer comprises a frame and a stencil coupled to the frame. The stencil has a plurality of apertures formed therein. The stencil printer further comprises a support assembly coupled to the frame, the support assembly supporting the electronic substrate in a printing position. An imaging system is constructed and arranged to capture images of multiple areas of one of the electronic substrate and the stencil. The stencil printer further comprises means for controlling the movement of the imaging system to capture an image of an area while maintaining a minimum velocity above zero over the electronic substrate when capturing the image.

In one embodiment, the means for controlling the movement of the imaging system comprises a controller. The controller comprises a processor programmed to perform texture recognition of the electronic substrate to determine the accuracy of the solder paste deposits on the pads of the electronic substrate. The imaging system may be configured to capture an image of solder paste on a pad of the electronic substrate within the area. The imaging system comprises at least one camera, at least one lens assembly, at least one illumination device and at least one optical path adapted to reflect light between the at least one illumination device, one of the stencil and the electronic substrate, the at least one lens assembly and the at least one camera. The at least one illumination device comprises at least one light emitting diode. The optical path comprises at least one beam splitter and a mirror. In another embodiment, the imaging system comprises a first camera, a first lens assembly, a first illumination device and a first optical path adapted to reflect light between the first illumination device, the electronic substrate, the lens assembly and the first camera, and a second camera, a second lens assembly, a second illumination device, and a second optical path adapted to reflect light between the second illumination device, the stencil, the lens assembly and the second camera. The time to capture an image is less than five milliseconds. The stencil printer further comprises a dispenser, coupled to the frame, the dispenser being constructed and arranged to dispense solder paste onto the electronic substrate.

### BRIEF DESCRIPTION OF THE DRAWINGS

In the drawings, like reference characters refer to the same or similar parts throughout the different views. The drawings are not necessarily to scale, emphasis instead being placed upon illustrating particular principles, discussed below.

FIG. 1 is a schematic view of a prior art imaging system;

FIG. 2 is a graph representing the velocity versus time of the prior art imaging system;

FIG. 3 is a front perspective view of a stencil printer of an embodiment of the present invention;

FIG. 4 is a schematic view of an imaging system of an embodiment of the present invention;

FIG. 5 is an enlarged schematic view of a camera and lens assembly of the imaging system illustrated in FIG. 4;

FIG. 6 is a graph representing the velocity versus time of the imaging system illustrated in FIG. 4;

FIG. 7 is a flow diagram of a method of dispensing solder paste onto electronic pads of an electronic substrate of an embodiment of the invention;

FIG. 8 is a schematic view of an imaging system used to perform a texture recognition method of an embodiment of the invention;

FIG. 9 is a schematic representation of a substrate; and

FIG. 10 is a schematic representation of a substrate having solder paste deposited on the substrate.

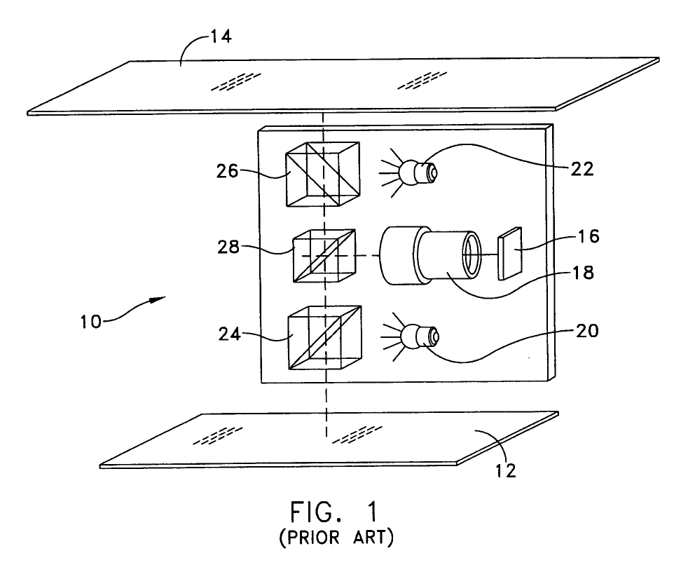

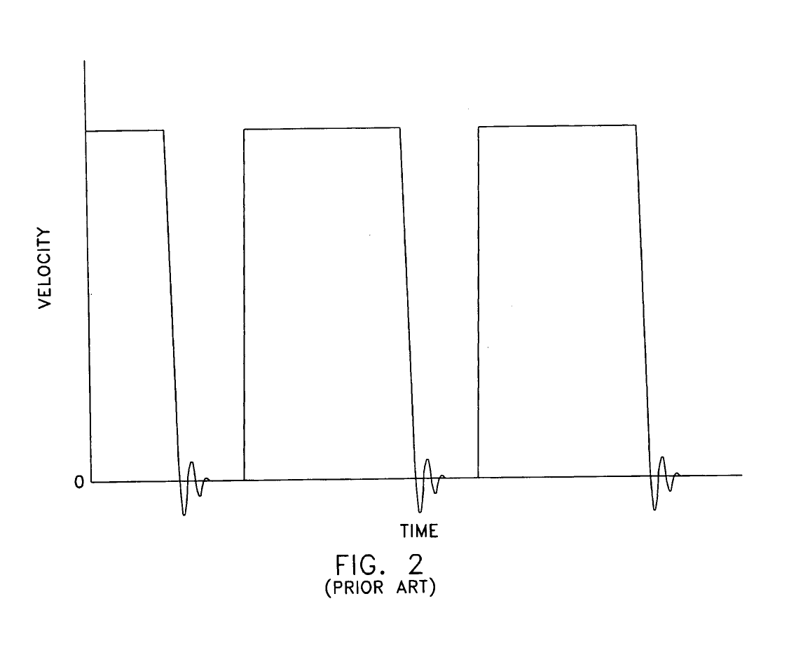

### DETAILED DESCRIPTION OF THE INVENTION

For purposes of illustration, embodiments of the present invention will now be described with reference to a stencil printer used to print solder paste onto a circuit board. One skilled in the art will appreciate that embodiments of the present invention are not limited to stencil printers that print solder paste onto circuit boards, but rather, may be used in other applications requiring dispensing of other viscous materials, such as glues, encapsulents, underfills, and other assembly materials suitable for attaching electronic components onto a circuit board. Thus, any reference to solder paste herein contemplates use of such other materials. Also, the terms “screen” and “stencil” may be used interchangeably herein to describe a device in a printer that defines a pattern to be printed onto a substrate.

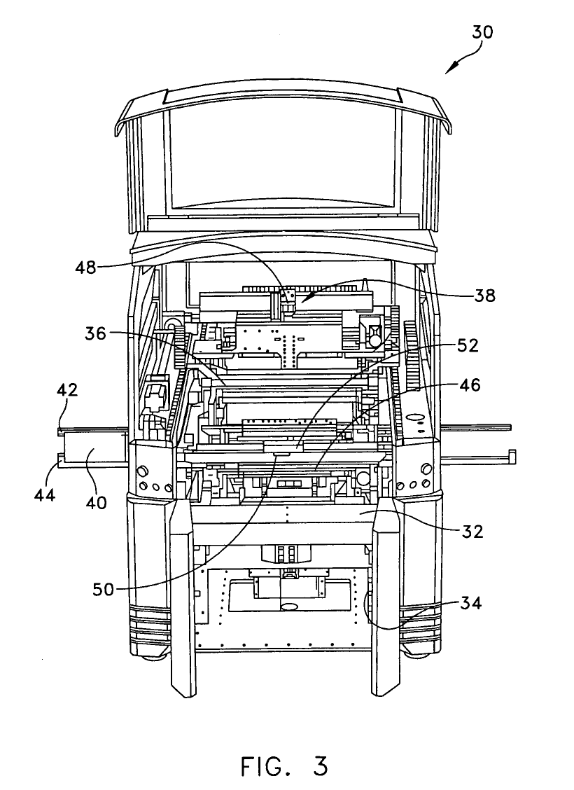

FIG. 3 shows a front perspective view of a stencil printer, generally indicated at 30, in accordance with one embodiment of the present invention. The stencil printer 30 includes a frame 32 that supports components of the stencil printer including a controller 34 located in the cabinet of the stencil printer, a stencil 36, and a dispensing head, generally indicated at 38, for dispensing solder paste. The dispensing head 38 is movable along orthogonal axes by a gantry system (not designated) under the control of the controller 34 to allow printing of solder paste on a circuit board 40.

Stencil printer 30 also includes a conveyor system having rails 42, 44 for transporting the circuit board 40 to a printing position in the stencil printer 30. The stencil printer 30 has a support assembly 46 (e.g., pins, gel membranes, etc.) positioned beneath the circuit board 40 when the circuit board is in the dispensing position. The support assembly 46 is used to raise the circuit board 40 off of the rails 42, 44 to place the circuit board in contact with, or in close proximity to, the stencil 36 when printing is to occur.

In one embodiment, the dispensing head 38 is configured to receive at least one solder paste cartridge 48 that provides solder paste to the dispensing head during a printing operation. In one embodiment, the solder paste cartridge 48 is coupled to one end of a pneumatic air hose in the well known manner. The other end of the pneumatic air hose is attached to a compressor contained within the frame 32 of the stencil printer 30 that under the control of the controller 34 provides pressurized air to the cartridge 48 to force solder paste into the dispensing head 38 and onto the stencil 36. Other configurations for dispensing solder paste onto the stencil may also be employed. For example, in another embodiment, mechanical devices, such as a piston, may be used in addition to, or in place of, air pressure to force the solder paste from the cartridge 48 into the dispensing head 38. In yet another embodiment, the controller 34 is implemented using a personal computer having a suitable operating system (e.g., Microsoft® DOS or Windows® NT) with application specific software to control the operation of the stencil printer as described herein.

The stencil printer 30 operates as follows. A circuit board 40 is loaded into the stencil printer 30 in a print position using the conveyor rails 42, 44. The dispensing head 38 is then lowered in the Z-direction until it is in contact with the stencil 36. The dispensing head 38 fully traverses the stencil 36 in a first print stroke to force solder paste through apertures of the stencil 36 and onto the circuit board 40. Once the dispensing head 38 has fully traversed the stencil 36, the circuit board 40 is transported by the conveyor rails 42, 44 from the printer 30 so that a second, subsequent circuit board may be loaded into the printer. To print on the second circuit board, the dispensing head 38 may be moved in a second print stroke across the stencil 36 in an opposite direction to that used for the first circuit board.

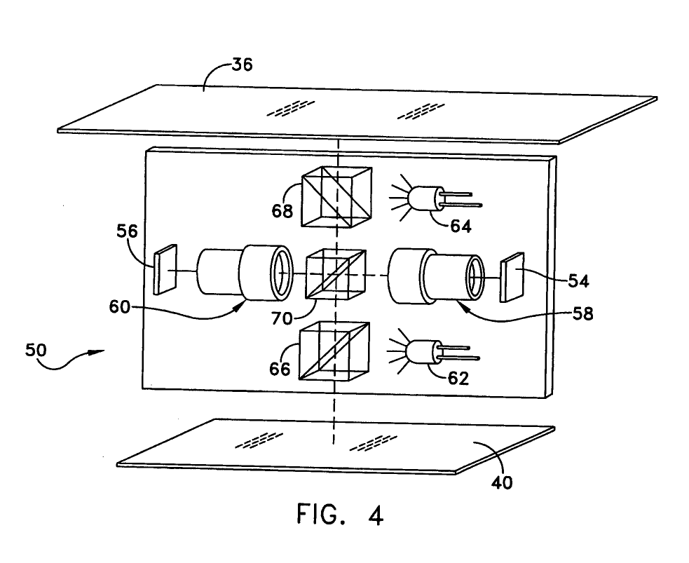

Referring to FIGS. 3 and 4, an imaging system of an embodiment of the present invention is generally designated at 50. As shown in FIG. 3, the imaging system 50 is disposed between the stencil 36 and the circuit board 40. The imaging system 50 is coupled to a gantry system 52, which may be part of the gantry used to move the dispensing head 28 or provided separately within the stencil printer 30. The construction of the gantry system 52 used to move the imaging system 50 is well known in the art of solder paste printing. The arrangement is such that the imaging system may be located at any position below the stencil 36 and above the circuit board 40 to capture an image of predefined areas of the board or the stencil, respectively. In other embodiments, when positioning the imaging system outside the printing nest, the imaging system may be located above or below the stencil and the circuit board.

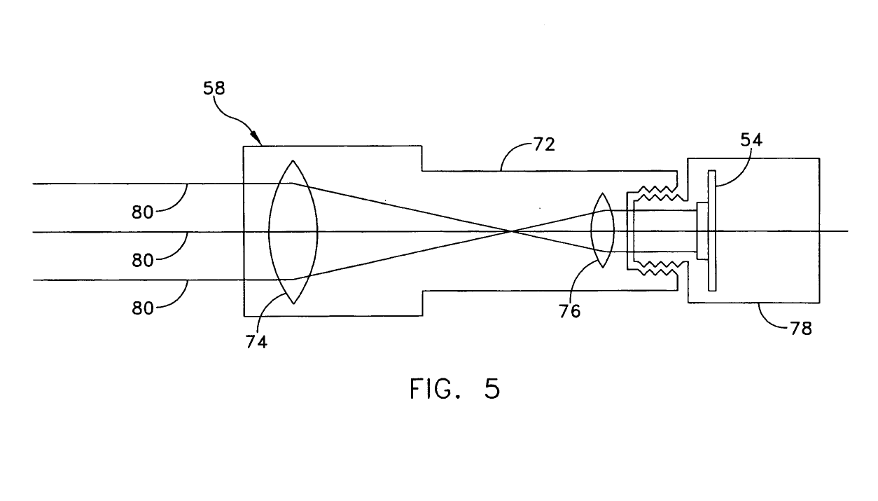

As shown in FIG. 4, the imaging system 50 comprises an optical assembly having two cameras 54, 56, two lens assemblies generally indicated at 58, 60, two illumination devices 62, 64, two beam splitters 66, 68, and a mirror 70. The cameras 54, 56 may be identical in construction with respect to one another, and, in one embodiment, each camera may be a digital CCD camera of the type that may be purchased from Opteon Corporation of Cambridge, Massachusetts under Model No. CHEAMDPCACELA010100. Further description of the cameras 54, 56 will be provided below with reference to FIG. 5.

In one embodiment, the illumination devices 62, 64 may be one or more light emitting diodes (white light diodes) that are capable of generating an intense amount of light at their respective beam splitter 66, 68. The illumination devices 62, 64 may be of the type sold by Nichia Corporation of Detroit, Mich. under Model No. NSPW310BSB1B2/ST. The beam splitters 66, 68 and the mirror 70, which is a dual mirror with zero beam split, are well known in the art. In other embodiments, xenon and halogen lamps may be used to generate the light required. Fiber optics can also be used to convey light from the remote source to the point of use.

The beam splitters 66, 68 are designed to reflect a portion of the light generated by their respective illumination devices 62, 64 toward the circuit board 40 and the stencil 36, respectively, while further allowing a portion of the light reflected by the circuit board and the stencil pass through to the mirror 70. The optical paths defined between the illumination devices 62, 64 and their respective cameras 54, 56 by means of beam splitters 66, 68 and mirror 70 are well known to a person skilled in the art. In one embodiment, the construction of the optical paths created by the beam splitters 66, 68 and the mirror 70 is substantially similar to the paths disclosed in U.S. Pat. No. 5,060,063, except that mirror 70 is a full mirror (due to the provision of the two cameras 54, 56) and does not allow part of the light to pass therethrough.

Referring to FIG. 5, camera 54 and lens assembly 58 are illustrated. As discussed above, camera 56 may be identical in construction to camera 54. In addition, the construction of lens assembly 60 may be identical in construction to lens assembly 58. Accordingly, the following discussion of camera 54 and lens assembly 58 generally applies for camera 56 and lens assembly 60, respectively. As shown schematically, lens assembly 58 includes a housing 72, a pair of lenses 74, 76 disposed within the housing and an aperture (not shown) disposed between the lenses 74, 76. The lenses 74, 76 together provide the telecentric capability of the lens assembly 58. The collective lens assembly may also be referred to as a “lens,” which is specifically referred to herein as the telecentric lens assembly 58 or 60. The arrangement is such that light reflected from the mirror 70 is directed to the lens assembly 58. Once in the lens assembly 58, the light passes through lens 74, through the aperture (not shown), through the second lens 76, and on to the image-sensitive region of the camera 54. In one embodiment the CCD reader of the camera 54 may include an electronic shutter. The camera 54, in part due to the telecentric lens assembly 58, is designed to view an entire predefined area without exhibiting distortion at or near the periphery of the image.

As shown in FIG. 5, the camera 54 is supported by a housing 78, which may be threadably attached to the housing 72 of the lens assembly 58. The housing 72 of the lens assembly 58 and the housing 78 of the camera 54 are in axial alignment with one another so that the image, which is represented in ray-form by lines 80, is accurately directed toward the camera.

The arrangement is such that when taking an image of the circuit board 40, the illumination device 62 generates an intense amount of light toward its respective beam splitter 66. This light is reflected by the beam splitter 66 toward the circuit board 40, and is then reflected back toward the mirror 70. The mirror 70 directs the light to the camera 54, which captures the image of the predefined area of the circuit board 40. The image may be electronically stored or used in real-time so that the image may be manipulated and analyzed by the controller 34 to either detect a defective solder deposit or align the circuit board 40 with the stencil 36, for example.

Similarly, when taking an image of the stencil 36, the illumination device 64 generates a beam of light that is directed toward its respective beam splitter 68. The light is then directed toward the stencil 36 and reflects back through the beam splitter 68 to the mirror 70. The light is then directed toward the telecentric lens assembly 60 and on to the camera 56 to capture the image of the predefined area of the stencil 36. Once captured, the area of the stencil 36 may be analyzed by the controller 34 for inspection purposes (e.g., detecting clogged apertures in the stencil, for example), or compared to an area of the circuit board 40 for alignment purposes. The inspection capability of the imaging system 50 will be described in greater detail below with reference to the description of a texture recognition program.

With the configuration illustrated in FIG. 4, the imaging system 50 is capable of moving from predefined area to predefined area while taking an image in approximately 105 milliseconds, with approximately 100 milliseconds attributable to moving the imaging system from one predefined area to another predefined area and approximately 5 milliseconds attributable to taking the image while maintaining a minimum velocity. It has been found that the imaging system of the invention is capable of taking an image without significant distortion or blurring while maintaining a minimum velocity of at least 1 millimeter per second. In one embodiment, the imaging system is capable of maintaining a minimum velocity of at least 3 millimeters per second. Although maintaining a minimum velocity, the imaging system 50 cannot travel across the stencil 36 and/or the circuit board 40 more than a distance equivalent to ¼ pixel shift at the image plane of the camera 54 and/or 56. It has been discovered that the imaging system 50, during the exposure interval, may travel an equivalent distance at the image plane up to a ¼ pixel and still provide an acceptable image.

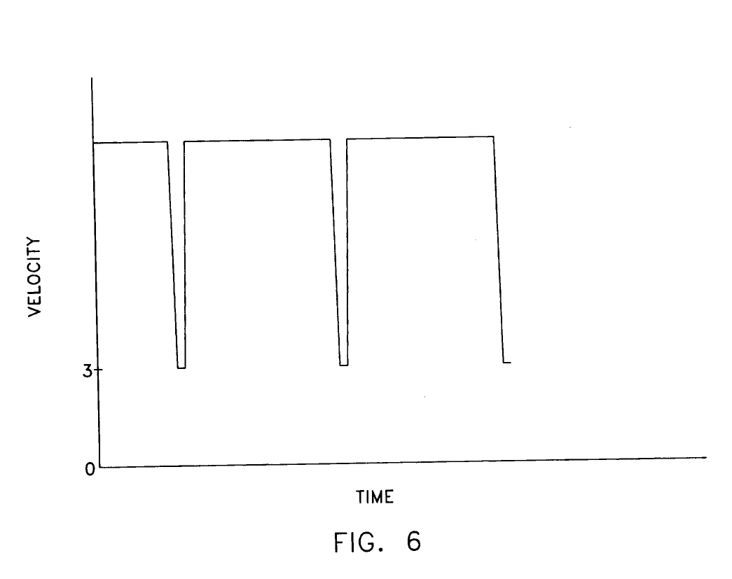

With reference to FIG. 6, in one embodiment, the imaging system 50, when taking an image of either the stencil 36 or the board 40, decelerates to capture the image, but always maintains a minimum, positive velocity. As shown, the imaging system 50, when approaching a predefined area for an image, decelerates, takes the image by opening and closing the electronic equivalent of a shutter, and accelerates to the next predefined area. The combination of intense light and reduced exposure time enables the imaging system to maintain a minimum positive velocity during image capture. Also, since the imaging system 50 maintains a minimum velocity and is not stopped less vibration or oscillation is introduced, and added time is not needed to ensure the vibration level of the imaging system is below a certain threshold. In one embodiment, the image is captured during a time when the imaging system travels a distance equivalent to less than ¼ pixel at the image plane. Accordingly, the imaging system of the invention enables the stencil printer 30 to quickly image predefined areas of the stencil and/or the board in significantly less time than prior art imaging systems.

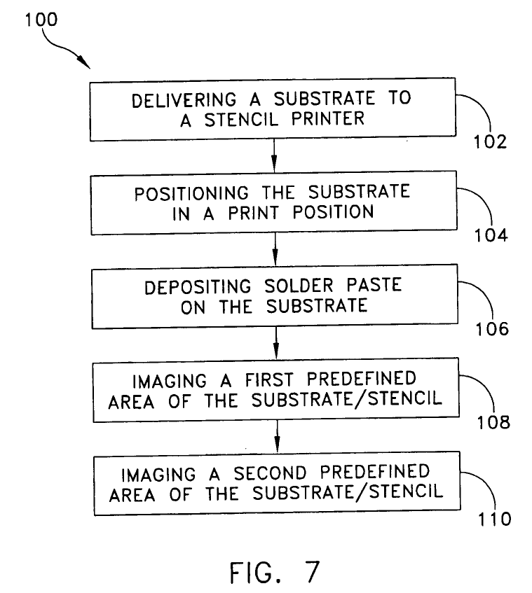

Turning now to FIG. 7, a method for dispensing solder paste onto electronic pads of a circuit board is generally designated at 100. As shown, at 102, a printed circuit board is delivered to a stencil printer 30 via a conveyor system, for example. With reference to FIG. 3, a circuit board 40 is delivered to the print nest via conveyor rails 42, 44. Once delivered, the circuit board is positioned within the print nest on top of the support 46 and raised by the support so that it is maintained in a print position. This is illustrated at 104 in FIG. 7. Next, the dispensing head 38 is lowered to engage the stencil 36 to deposit solder paste on the circuit board 40 at 106. Once printing is completed, inspection of the circuit board and/or stencil may take place.

Specifically, a predefined area of either the circuit board or the stencil is imaged at 108. Next, at 110, a subsequent predefined area of either the circuit board or the stencil is imaged. The imaging of multiple predefined areas of the circuit board is executed while maintaining a minimum velocity above zero over the circuit board when moving from the first predefined area to the second predefined area as illustrated in FIG. 6. Under the direction of the controller 34, the imaging system 50 sequentially moves to other predefined areas to capture images for inspection or alignment purposes.

In one embodiment, the imaging system 50 may be used to perform a texture recognition method, such as the method disclosed in U.S. Pat. No. 6,738,505 to Prince, entitled METHOD AND APPARATUS FOR DETECTING SOLDER PASTE DEPOSITS ON SUBSTRATES, which is owned by the assignee of the present invention and incorporated herein by reference. U.S. Pat. No. 6,891,967 to Prince, entitled SYSTEMS AND METHODS FOR DETECTING DEFECTS IN PRINTED SOLDER PASTE, which is also owned by the assignee of the present invention and incorporated herein by reference, furthers the teachings of U.S. Pat. No. 6,738,505. Specifically, these patents teach texture recognition methods for determining whether solder paste is properly deposited onto predetermined regions, e.g., copper contact pads, located on a printed circuit board.

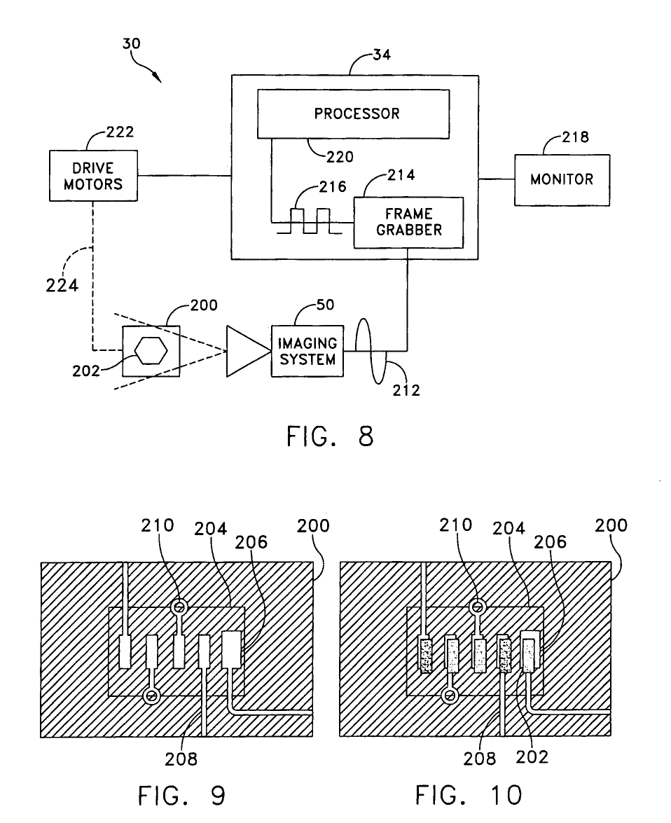

With reference to FIG. 8, in one embodiment, the screen printer 30 is shown inspecting a substrate 200 having a substance 202 deposited thereon. The substrate 200 may embody a printed circuit board, wafer, or similar flat surface, and the substance 202 may embody solder paste, or other viscous materials, such as glues, encapsulents, underfills, and other assembly materials suitable for attaching electronic components onto printed circuit boards or wafers. As shown in FIGS. 9 and 10, the substrate 200 has a region of interest 204 and contact regions 206. The substrate 200 further includes traces 208 and vias 210, which are used to interconnect components mounted on the substrate, for example. FIG. 9 illustrates the substrate 200 without substances deposited on any of the contact regions 206. FIG. 10 illustrates the substrate 200 having substances 202, e.g., solder paste deposits, distributed on the contact regions 206. In the substrate 200, the contact regions 206 are distributed across a designated region of interest 204.

FIG. 10 shows a misalignment of the solder paste deposits 202 with the contact regions 206. As shown, each of the solder paste deposits 202 is partially touching one of the contact regions 206. To ensure good electrical contact and to prevent bridging between adjacent contact regions, e.g., copper contact pads, the solder paste deposits should be aligned to respective contact regions within specific tolerances. Texture recognition methods of the types disclosed in U.S. Pat. Nos. 6,738,505 and 6,891,967 detect misaligned solder paste deposits on contact regions, and as a result, generally improve the manufacturing yield of the substrates.

Referring back to FIG. 8, in one embodiment, a method for solder paste texture recognition includes using the imaging system 50 to capture an image of the substrate 200 having a substance 202 deposited on the substrate. The imaging system 50 may be configured to transmit a real-time signal 212 to an appropriate digital communication port or dedicated frame grabber 214. The digital port may include types commonly known as USB, Ethernet, or Firewire (IEEE 1394). The real-time signal 212 corresponds to an image of the substrate 200 having the substance deposited thereon. Once received, the port or frame grabber 214 creates image data 216 which may be displayed on a monitor 218. In one embodiment, the image data 216 is divided into a predetermined number of pixels, each having a brightness value from 0 to 255 gray levels. In one embodiment, the signal 212 represents a real-time image signal of the substrate 200 and the substance 202 deposited thereon. However, in other embodiments, the image is stored in local memory and transmitted to the controller 34 on demand, as required.

The port or frame grabber 214 is electrically connected to the controller 34, which includes a processor 220. The processor 220 calculates statistical variations in texture in the image 216 of the substance 202. The texture variations in the image 216 of the substance 202 are calculated independent of relative brightness of non-substance background features on the substrate 200, thereby enabling the processor 220 to determine the location of the substance on the substrate and compare the location of the substance with a desired location. In one embodiment, if the comparison between the desired location and the actual location of the substance 202 reveals misalignment exceeding a predefined threshold, the processor 220 responds with adaptive measures to reduce or eliminate the error, and may reject the substrate or trigger an alarm via the controller 34. The controller 34 is electrically connected to drive motors 222 of the stencil printer 30 to facilitate the alignment of the stencil 36 and the substrate 40 as well as other motion related to the printing process.

The controller 34 is part of a control loop 224 that includes the drive motors 222 of the stencil printer 30, the imaging system 50, the frame grabber 214 and the processor 220. The controller 34 sends a signal to adjust the alignment of the stencil 36 should the substance 202 be misaligned with the contact region 206.

Thus, it should be observed that the imaging system 50 of the present invention is particularly suited for capturing sharply focused and blur-free images as required to perform texture recognition methods while providing efficient real-time, closed-loop control, since the imaging system is capable of quickly imaging regions of interest (predefined areas) so that data can be quickly analyzed.

During operation, when depositing a substance on a substrate, an image is captured of the substance deposit. In one embodiment, the substance is solder paste and the substrate is a printed circuit board. The image of the substrate with the substance may be captured in real-time or retrieved from memory of the controller. The image is sent to the processor of the controller in which texture variations in the image are detected. These texture variations are used to determine the location of the substance on the substrate. The processor is programmed to compare the particular location of the substance with predetermined locations of the substrate. If variations are within predetermined limits, the processor may respond with adaptive measures to refine the process. If the variations lie outside predetermined limits, then an appropriate recovery measure may be employed in which the substrate is rejected, the process is terminated, or an alarm is triggered. The controller is programmed to perform any one or more of these functions if a defect is detected.

In one embodiment, the stencil and/or the circuit board may move relative to the camera to take images of the stencil and the board, respectively. For example, the stencil may be translated away from the print nest and moved over or under the camera, which may be stationary. Similarly, the circuit board may be shuttled away from the print nest and moved over or under the camera. The camera may then take an image of the stencil and/or circuit board in the manner described above, with the circuit board and/or stencil maintaining a minimum velocity.

In another embodiment, the imaging system may be employed within a dispenser designed to dispense viscous or semi-viscous materials, such as solder paste, glues, encapsulents, underfills, and other assembly materials on a substrate, such as a printed circuit board. Such dispensers are of the type sold by Speedline Technologies, Inc., under the brand name CAMALOT®.

The improved optical efficiency, mechanical stability, and parallel operation afforded by this invention reduces the time required to acquire images of both the electronic substrate and the stencil to less than a quarter of the time required when using prior imaging systems.

While this invention has been shown and described with references to particular embodiments thereof, those skilled in the art will understand that various changes in form and details may be made therein without departing from the scope of the invention, which is limited only to the following claims.

What is claimed is:

1. A stencil printer for depositing solder paste onto a plurality of pads of an electronic substrate, the stencil printer comprising:
a frame;
a stencil coupled to the frame, the stencil having a plurality of apertures formed therein;
a support assembly coupled to the frame, the support assembly supporting the electronic substrate in a printing position;
an imaging system constructed and arranged to capture images of multiple areas of one of the electronic substrate and the stencil; and
a controller coupled to the imaging system, the controller being constructed and arranged to control movement of the imaging system to capture an image of an area while maintaining a minimum velocity above zero when capturing the image of the area.

2. The stencil printer of claim 1, wherein the imaging system is constructed and arranged to capture an image of solder paste on a pad of the electronic substrate within the area.

3. The stencil printer of claim 1, wherein the imaging system comprises at least one camera, at least one lens assembly, at least one illumination device and at least one optical path adapted to reflect light between the at least one illumination device, one of the stencil and the electronic substrate, the at least one lens assembly, and the at least one camera.

4. The stencil printer of claim 3, wherein the at least one illumination device comprises at least one light emitting diode.

5. The stencil printer of claim 3, wherein the optical path comprises at least one beam splitter and a mirror.

6. The stencil printer of claim 1, wherein the imaging system comprises:
a first camera, a first lens assembly, a first illumination device and a first optical path adapted to reflect light between the first illumination device, the electronic substrate, the first lens assembly and the first camera, and
a second camera, a second lens assembly, a second illumination device, and a second optical path adapted to reflect light between the second illumination device, the stencil, the second lens assembly and the second camera.

7. The stencil printer of claim 1, wherein the time to capture an image is less than five milliseconds.

8. The stencil printer of claim 1, wherein the controller comprises a processor programmed to perform texture recognition of the electronic substrate to determine the accuracy of the solder paste deposits on the pads of the electronic substrate.

9. The stencil printer of claim 1, further comprising a dispenser, coupled to the frame, the dispenser being constructed and arranged to dispense solder paste onto the electronic substrate.

10. A method for dispensing solder paste onto electronic pads of an electronic substrate, the method comprising:
delivering an electronic substrate to a stencil printer;
positioning the electronic substrate in a print position;
positioning a stencil onto the electronic substrate;
performing a print operation to print solder paste onto the pads of the electronic substrate; and
capturing an image of at least one area of one of the electronic substrate and the stencil while maintaining a minimum velocity above zero over the electronic substrate when capturing the at least one image.

11. The method set forth in claim 10, wherein capturing an image of at least one area of one of the electronic substrate and the stencil employs an imaging system.

12. The method of claim 11, further comprising moving the imaging system from a first position that captures an image of a first area to a second position that captures an image of a second area.

13. The method of claim 12, wherein the time to capture an image is less than five milliseconds.

14. The method of claim 10, further comprising performing a texture recognition sequence of the at least one area to determine the accuracy of the solder paste deposits on the pads of the electronic substrate.

15. A stencil printer for depositing solder paste onto a plurality of pads of an electronic substrate, the stencil printer comprising:
a frame;
a stencil coupled to the frame, the stencil having a plurality of apertures formed therein;
a support assembly coupled to the frame, the support assembly supporting the electronic substrate in a printing position;
an imaging system constructed and arranged to capture images of multiple areas of one of the electronic substrate and the stencil; and
means for controlling the movement of the imaging system to capture an image of an area while maintaining a minimum velocity above zero over the electronic substrate when capturing the image.

16. The stencil printer of claim 15, wherein the means for controlling the movement of the imaging system comprises a controller.

17. The stencil printer of claim 16, wherein the controller comprises a processor programmed to perform texture recognition of the electronic substrate to determine the accuracy of the solder paste deposits on the pads of the electronic substrate.

18. The stencil printer of claim 15, wherein the imaging system is constructed and arranged to capture an image of solder paste on a pad of the electronic substrate within the area.

19. The stencil printer of claim 15, wherein the imaging system comprises at least one camera, at least one lens assembly, at least one illumination device and at least one optical path adapted to reflect light between the at least one illumination device, one of the stencil and the electronic substrate, the at least one lens assembly and the at least one camera.

20. The stencil printer of claim 19, wherein the at least one illumination device comprises at least one light emitting diode.

21. The stencil printer of claim 19, wherein the optical path comprises at least one beam splitter and a mirror.

22. The stencil printer of claim 15, wherein the imaging system comprises
a first camera, a first lens assembly, a first illumination device and a first optical path adapted to reflect light between the first illumination device, the electronic substrate, the first lens assembly and the first camera,
and a second camera, a second lens assembly, a second illumination device, and a second optical path adapted to reflect light between the second illumination device, the stencil, the second lens assembly and the second camera.

23. The stencil printer of claim 15, wherein the time to capture an image is less than five milliseconds.

24. The stencil printer of claim 15, further comprising a dispenser, coupled to the frame, the dispenser being constructed and arranged to dispense solder paste onto the electronic substrate.
